(19) United States
(12) Patent Application Publication
(10) Pub. No.: US 2009/0152176 A1
(43) Pub. Date: Jun. 18, 2009

(54) MAGNETIC SEPARATION OF FINE PARTICLES FROM COMPOSITIONS

(75) Inventors: James E. Kipp, Wauconda, IL (US); Joseph Chung Tak Wong, Long Grove, IL (US); Jane O. Werling, Arlington Heights, IL (US)

Correspondence Address: BAXTER HEALTHCARE CORPORATION, ONE BAXTER PARKWAY, DF2-2E, DEERFIELD, IL, 60015, US

(73) Assignees: BAXTER INTERNATIONAL INC., Deerfield, IL (US); BAXTER HEALTHCARE S.A., Wallisellen (CH)

(21) Appl. No.: 11/962,884

(22) Filed: Dec. 21, 2007

Related U.S. Application Data
(60) Provisional application No. 60/871,781, filed on Dec. 23, 2006.

(51) Int. Cl. B07C 5/344; B03C 1/00

(52) U.S. Cl. 209/562; 209/636; 209/212; 209/213

(57) ABSTRACT

The disclosure describes apparatuses and methods of use that may be used to remove material with magnetic properties from compositions, particularly pharmaceutical compositions. The apparatuses provide a conduit or column in which a magnetic field exists and through which a composition flows. Magnetic material in the composition is substantially reduced after flowing through the conduit or column.

### CROSS-REFERENCE TO RELATED APPLICATION

The benefit under 35 U.S.C. §119(e) of U.S. provisional patent application Ser. No. 60/871,781 filed Dec. 23, 2006, the entire disclosure of which is incorporated herein by reference, is hereby claimed.

### DESCRIPTION

1. Field of the Disclosure

The disclosure relates to compositions, apparatuses and systems for use in the removal of magnetic material from compositions, particularly pharmaceutical compositions.

2. Background

Many applications require the separation of particles from a composition. Filtration is a widely used method to remove particulate matter. In one commonly used version of this method, a membrane is inserted into the flow of the preparation and particles are unable to pass through the pores of the membrane due to their size. The filtration membrane may also include materials such that the particles absorb to the membrane. The composition with reduced amounts of particles is collected as the filtrate. However, filtration may not be desirable in situations where small particles are present and membranes with very small pore sizes are required because an unacceptably large increase in mechanically applied pressure may be necessary to maintain the flow rate. In addition, filtration may be difficult where the initial viscosity of the solution is high or where the one or more of the components of the composition is not compatible with the membrane. Also, filtration may be completely impossible in situations where the active agent is itself in the form of particles in suspension. In these cases, filtration may remove the active agent particles as well as undesirable particles.

An alternative method of separating particles takes advantage of their magnetic properties. Generally, if a magnetic field is applied to a solution containing material with magnetic properties, then that material will be drawn to the source of the magnetic field and will be separated from the solution. The use of magnetic fields to separate components from solution has been exploited in applications where it is necessary to purify a particular component from a solution. For example, an antibody may be linked to a magnetic particle and the antibody-particle complex mixed with blood. The antibody will interact with its corresponding antigen in the solution. When a magnetic field is applied, the antibody-antigen-magnetic particle complex can be separated from the blood.

Material with magnetic properties may also arise during the production of a composition. For example, during the production of pharmaceutical compositions, one source of metal particles comes from the metal used in devices such as reaction vessels, stirrers, homogenizers, grinders and ball milling apparatus. The presence of these particles even at very low levels is undesirable and the use of magnetic fields presents one method to remove them and achieve the required purity for the composition. These metal particles may arise from metals such as allotropes of iron (e.g., ferrite, austenite, martensite), alloys of iron and carbon (such as stainless steel, with or without added elements such as nickel, cobalt, molybdenum, chromium or vanadium), lanthanides (such as gadolinium, europium, and dysprosium), or paramagnetic materials such as aluminum, titanium, and their alloys. Ceramic materials may also be magnetic. Magnetic ceramics may be generated by mixing metal oxides (e.g., ZnO, FeO, MnO, NiO, BaO, or SrO) with Fe₂O₃. These ceramics find use in permanent magnets, computer memory, and in telecommunications.

Stainless steel is defined as a ferrous alloy with a minimum of 10.5% chromium content. The presence of chromium results in a higher resistance to rust and corrosion. The magnetic properties of stainless steel vary depending on the elemental composition of the steel. Alloys with relatively low concentrations of nickel or manganese are ferromagnetic. In these alloys, a martensite crystalline structure predominates and the steel will respond strongly to magnetic fields. Steel alloys with higher concentrations of nickel or manganese assume a stabilized austenite crystalline configuration. The austenitic steels are generally considered non-magnetic but in fact are paramagnetic and will respond to strong magnetic fields (on the order of 1 TESLA). Pure titanium or aluminum are paramagnetic and are expected to respond to strong magnetic fields.

U.S. Published Patent Application No. 2003/0108613 by Weitschies et al, which is herein incorporated by reference, describes a device for the magnetic separation of pharmaceutical preparations. The device consists of a separation space in which a magnetic field prevails and which has an inlet and an outlet. However, the device is intended to be used only as an attachment filter for infusion and injection instruments or to be integrated into such instruments. There remains a need for apparatuses, systems and methods for using them which are able to separate magnetic material and which are more easily adapted into processes for formulating compositions.

### SUMMARY

The disclosure provides for apparatuses, systems and methods to substantially remove magnetic material from compositions, particularly pharmaceutical compositions.

In one embodiment, the disclosure provides for a conduit through which a composition passes or is maintained. The conduit passes adjacent to an arrangement of magnets and the composition is subject to a magnetic field that substantially removes material with magnetic properties.

In one embodiment, an arrangement of magnets is formed from magnets that are arranged in at least one double Halbach array. The conduit passes through a space between the halves of the array, substantially removing material with magnetic properties from a composition that flows through the conduit.

In another embodiment, a column contains magnetic beads. A composition passes through the column, and material with magnetic properties is substantially removed.

The disclosure also provides for systems that incorporate the apparatuses of the disclosure as well as methods for using the apparatuses.

### BRIEF DESCRIPTION OF THE DRAWINGS

FIGS. 1a and 1b show cross-sectional views of apparatuses according to the disclosure.

FIG. 2 shows a cross-sectional view of an apparatus according to the disclosure.

FIGS. 3a and 3b show schematics of two possible arrangements of magnets according to the disclosure.

FIGS. 4a to 4e show schematics of the possible orientations of the magnetic fields of split ring magnets according the disclosure.

FIG. 5 is a schematic showing an arrangement of magnets that form a Halbach array.

FIGS. 6a and 6b are schematics showing an arrangement of magnets that form a double Halbach array, in an (a) aligned or (b) opposed arrangement according to the disclosure.

FIG. 7 is a schematic showing an arrangement of ring magnets that form a double Halbach aligned array.

FIG. 8 shows magnetic field lines and flux as determined by finite element analysis of the arrangement of magnets shown in FIG. 7.

FIGS. 9a and 9b are schematics showing an arrangement of magnets forming multiple double Halbach arrays according to the disclosure.

FIGS. 10a (double Halbach aligned), 10b (double Halbach opposed) and 10c (diametrically oriented array elements as shown in FIG. 3a using whole magnets) show magnetic field lines and flux as determined from finite element analysis of arrangements of magnets according to the disclosure.

FIG. 11 shows a cross-sectional view of an embodiment of an apparatus according to the disclosure.

FIGS. 12a and 12b show a side view of an embodiment of an apparatus according to the disclosure.

FIG. 13 is a graph showing a plot of magnetic field strength across the inner diameter of a split ring magnet in which the magnetic fields are diametric and antipodal (south-to-south).

FIG. 14 shows an embodiment of a system for removing magnetic material from a composition according to the disclosure

FIG. 15 shows another embodiment of a system for removing magnetic material from a composition according to the disclosure.

FIG. 16 is a graph showing the ability of several embodiments according to the disclosure to remove magnetic material from a composition.

FIG. 17 is a graph showing the residual iron in a composition treated to remove magnetic material from a composition using embodiments of the disclosure.

FIG. 18 is a graph showing the ability of several disclosed embodiments to remove magnetic material from a composition at different flow rates and with different numbers of passages.

FIG. 19 is a photograph showing the absorption of magnetic material to tubing as described in the disclosure.

FIG. 20 is a graph showing the separation of magnetic material as described in Example 4.

### DESCRIPTION OF THE PREFERRED EMBODIMENTS

As required, detailed embodiments of the present disclosure are disclosed herein; however, it is to be understood that the disclosed embodiments are merely exemplary of the disclosure, which may be embodied in various forms. Therefore, specific details disclosed herein are not to be interpreted as limiting, but merely as a basis for the claims and as a representative basis for teaching one skilled in the art to variously employ the present disclosure in virtually any appropriate manner.

This disclosure concerns apparatuses and systems for the separation or removal of ferromagnetic, ferrimagnetic, paramagnetic, or superparamagnetic particulate material from compositions that are in the form of a fluid or solid. The fluid may be either a solution or a fluid containing dispersed particles. The composition may be solid such as a finely divided powder that can be passed through the apparatuses of the disclosure using a stream of carrier gas. The present disclosure can be used in numerous applications where it is desirable to remove material that is responsive to magnetic fields, including magnetic material of a very small size. These applications include petroleum products, pharmaceutical compositions, magnetic recording media, food products and drinking water purification. In one embodiment, the apparatuses and methods of the disclosure are used with pharmaceutical compositions.

The present disclosure can also be used in any industrial process in which magnetic particles are intentionally added as a catalyst or manufacturing aid that needs to be removed at the end of the manufacturing process. In biotechnology, for example, the disclosure is applicable to situations where desired biochemicals or biologicals including cells or tissue should be separated from other components during or at the end of a process (e.g., fermentation). For example, magnetic beads coated with molecules (e.g., antibodies) that specifically interact with the desired product are added, the interaction occurs, and the magnetic beads with the attached desired product are removed. The final product is detached from the beads, which can then be recycled. This is exemplified in U.S. Pat. No. 4,628,037 which is herein incorporated by reference. Another example is in U.S. Pat. No. 5,916,743 which is also herein incorporated by reference. This latter patent discloses a cell-separation method combining the techniques of immunoaffinity separation and continuous flow centrifugal separation for selective separation of a nucleated heterogeneous cell population from a heterogeneous cell mixture. The heterogeneous cell mixture is intimately contacted to promote binding thereto by particles having attached a substance that actively binds to a specific desired type of cell out of the cell mixture. The particles are selected so that the sedimentation velocity of the particle/cell conjugate differs sufficiently from those of other cells in the cell mixture to allow its separation by means of a continuous flow cell separator. The method rapidly processes large volumes of cell mixture with the high accuracy expected of immunoaffinity separation and can be used to separate, for example, various types of leukocytes from whole blood, bone marrow concentrate, or a peripheral blood stem cell concentrate; or precursors of lymphokine activated killer cells, tumor infiltrating lymphocyte cells, or activated killer monocytes from lymphocyte or monocyte cell concentrates or from a tissue cell preparation. In this case, the present disclosure can be used as an alternative separation method to immunoaffinity purification and separation techniques.

In general, the apparatuses provide for a separation zone to which a magnetic field is applied and through which a composition passes or is maintained. The apparatuses include an arrangement of magnets that produce a magnetic field of sufficient force to remove magnetic material such that the treated composition is rendered substantially free of magnetic material or at least within required limits. The apparatuses described here are capable of being physically integrated into systems used to make compositions such that the separation of magnetic material becomes an easily accomplished step in the process of the commercial production of compositions. Alternatively, the apparatuses of the disclosure may be used separately from the other processes during production of compositions.

The apparatuses and methods disclosed here are capable of removing material with magnetic properties including material with ferromagnetic, ferrimagnetic, paramagnetic and superparamagnetic properties. In one embodiment, the composition is a pharmaceutical composition, and the active agent or agents of the composition are generally non-magnetic or diamagnetic, whether the active agent forms a homogeneous solution or is in the form of dispersed particles in suspension. In this embodiment, undesirable magnetic material is removed and the active agent is substantially retained in the composition. In an alternative embodiment, the active agent may have magnetic properties and the apparatuses are used to separate out the active agent from other components of the composition.

It is generally noted that the disclosure can be especially efficient in removing smaller particles from a composition that includes different sizes of particles to be removed.

In one embodiment, the apparatuses may separate particles of stainless steel or other metals that may originate from the machinery used during the production of pharmaceutical compositions, including particles that originate from alloys of stainless steel that are generally considered non-magnetic. Although not wishing to be bound by theory, these alloys may be non-magnetic on a large scale but the smaller magnetic particles that originate from abrasive processes may have magnetic properties. On a large scale, there may be no net magnetization because randomly oriented magnetic domains within the molecular structure of the steel cancel each other. However, particles may have a single isolated domain or a small collection of domains and have net magnetic properties. Domain sizes vary considerably from a few nm to over 10 microns, depending on the type of material and how it was processed (Fourlaris G; Maylin M G; Gladman T. Magnetic domain imaging and mechanical/magnetic property characterization of a 2507 type duplex austenitic-ferritic stainless steel. Materials Science Forum, 1999, Vol 318-320, pp 823-828). In addition, abrasive stress is known to cause a transition from an austenitic crystalline form found in many stainless steels to a martensitic form. The latter form has ferromagnetic properties and responds to magnetic fields. Furthermore, austenite is paramagnetic and responds to very strong magnetic fields.

Magnets formed from a number of elements can be used for the disclosed magnetic separations depending on the nature of the material to be separated. The removal of small particles by magnetic attraction is enhanced by the use of magnets with very strong magnetic fields. In this case, the rare earth composite neodymium-iron-boron (NdFeB) typically is an advantageous choice. NdFeB has the highest residual magnetic flux density (Br) and resistance to demagnetization (also called coercivity [Hc]) of any magnet formula. The maximum flux density at the surface of NdFeB is approximately 10,000 gauss (1 Tesla). Samarium Cobalt (SmCo) is another preferred material. The magnets may be bar-shaped, horseshoe-shaped or ring-shaped, for example.

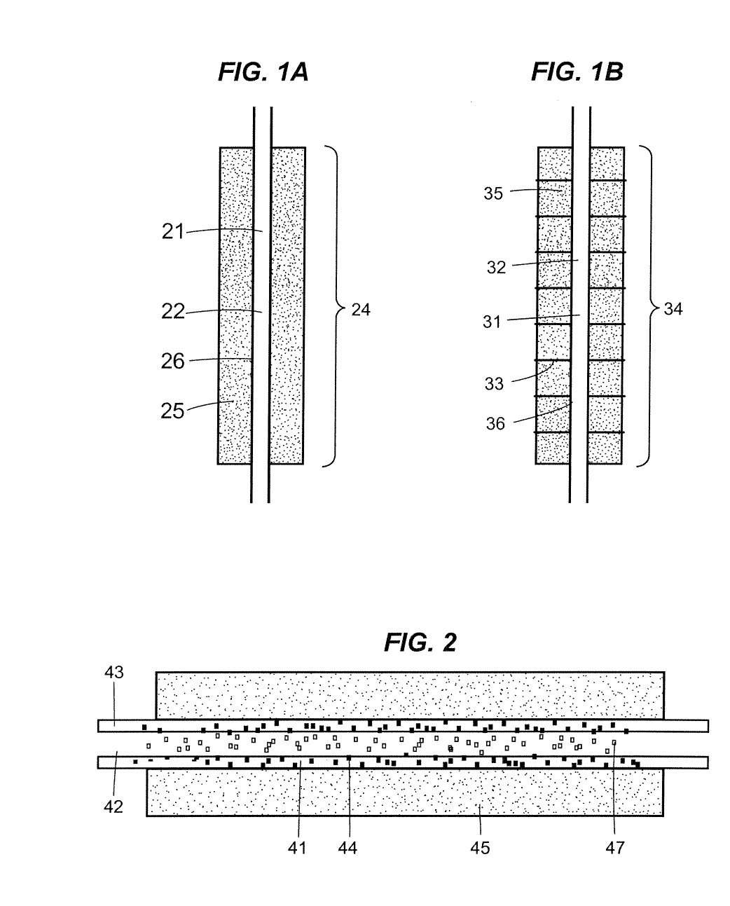

FIG. 1a shows one embodiment of an apparatus that can achieve the separation of magnetic material. The apparatus has a conduit 21 with an interior volume 22 that carries a composition, such as a pharmaceutical composition. The conduit 21 passes through a zone 24 containing a magnetic field. The magnetic field is generated by an arrangement 25 of at least one magnet. In this and other embodiments, the conduit passes through a gap 26 in the arrangement of magnets where the magnetic field prevails.

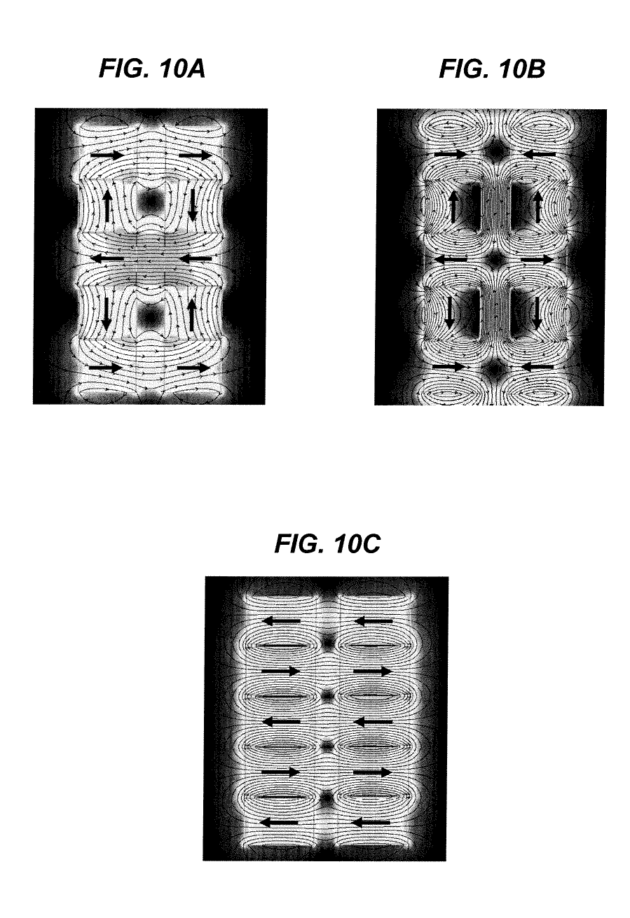

The removal of magnetic material is achieved when the composition containing the magnetic material passes through the conduit and the magnetic particles are drawn to the interior surface of the conduit by the magnetic field. As shown in FIG. 2 the conduit 41 with interior volume 42 may have properties of its interior surface or features on its internal surface 44 (such as a matrix 43) that impede, retain or trap the particles 47 when they are attracted to the internal surface of the conduit 41 by the magnetic field produced by the arrangement of magnets 45. When provided, a matrix feature may consist of elastomeric, tacky or fibrous material. FIG. 19 illustrates this aspect of the present disclosure. A composition containing magnetic material was passed through silicone tubing and subjected to a magnetic field. The magnetic field and composition were removed and the tubing examined. Dark bands representing magnetic material can be seen as being retained on the inside surface of the tubing. The bands are separated by 0.5 inch, which corresponds to the width of each magnetic element in the array of magnets used in this particular embodiment. In this embodiment, the magnetic material absorbs most obviously by visual inspection to the tubing in periodic regions of high magnetic field gradient. These regions are predicted by finite-element analysis (FIG. 10c) and occur near the magnet junctions where field lines emanate and where line spacing changes most with increasing distance from the gap into the central space of the magnet array.

The conduit, for example, may be non-magnetic tubing that is compatible with pharmaceutical compositions. The conduit may be adapted such that it can be integrated into a system for production of a pharmaceutical composition. For example, one end of the conduit may be adapted to receive the pharmaceutical composition from a previous step in processing and the second end may be adapted to re-circulate the pharmaceutical composition through the first end of the conduit to repeat the magnetic separation step or to the next step in processing of the pharmaceutical composition. The effluent contains no magnetic particles, or a quantity of magnetic particles significantly lower than that in the initial composition. Alternatively, the apparatus may be separate from the other components of the production system.

In the embodiment shown in FIG. 1a, a conduit passes through a separation zone where a magnetic field is formed by a single magnet. The magnetic field may be orientated in the same orientation as the flow of the composition or it may be orientated transversely to the flow or at any angle between these orientations.

In FIG. 1b, representing another embodiment of this disclosure, the conduit 31 with interior volume 32 passes through the separation zone 34 which is formed by more than one magnet 35 separated with optional spacers 33, formed from non-magnetic or ferromagnetic material, that are inserted between each magnet 35. The conduit passes through a gap 36 in the arrangement of magnets. In a further embodiment of this segmented design, spacers are not inserted between segments, and thus the magnets are in direct contact with each other. The magnetic field orientation of each magnet may be parallel or perpendicular to the direction of flow of the composition or may be orientated at some angle between these two positions. For the purposes of this disclosure the orientation of a magnetic field is shown in various drawings by an arrow with the arrowhead pointing in the direction of North.

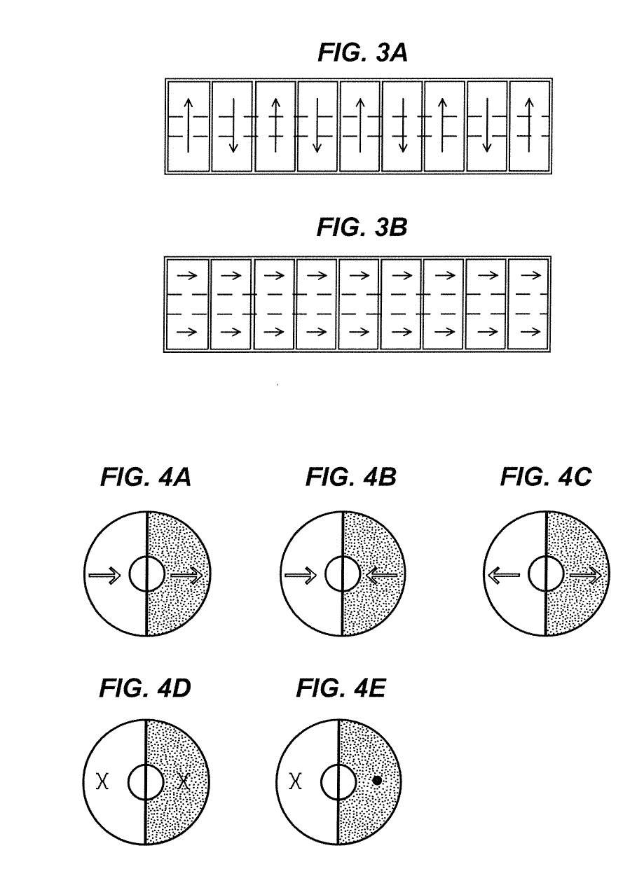

For example, in one embodiment of an array of magnets (FIG. 3a), the field of each magnet runs transversely and perpendicular to the direction of flow of the composition (“diametric orientation”). The field orientation may also run parallel to the direction of flow (“axial orientation”). In FIG. 3a, the diametric orientation of each successive segment runs in the opposite direction (“antipodal”). The magnetic orientation of each element in the array also may be axial, or parallel to the major axis as shown in FIG. 3b. In these examples the magnetic field vectors of each magnet are aligned in the same direction, although it is to be emphasized that any magnet in the array may be arranged such that its magnetic field may assume any orientation with respect to other magnets in the array.

In a further embodiment, the magnetic field results from a series of ring magnets such that each split pair comprises one segment. Each half of the pair may have any magnetic field orientation. FIG. 4 illustrates possible orientations. In FIG. 4a, the field of each half is diametric and both fields are aligned to point in the same direction. In this configuration, a whole magnet (unsplit) with diametric magnetization may also be used instead of a split pair. In FIG. 4b, the field of each half is diametric, but both vectors point in opposite directions, and antipodal (the North pole of one half abuts the North pole of the other half). In FIG. 4c, the fields are diametric and antipodal, but are oriented so that the South pole of one half-element abuts the South pole of the other half. FIG. 4d shows a split element pair, in which the field vectors are axially oriented and run in the same direction (X=South, •=North). As with the configuration in FIG. 4a, a whole magnet (i.e. unsplit) that is magnetized in the axial direction may be used instead of the split pair. FIG. 4e shows a split element pair in which the axial fields run in opposite directions.

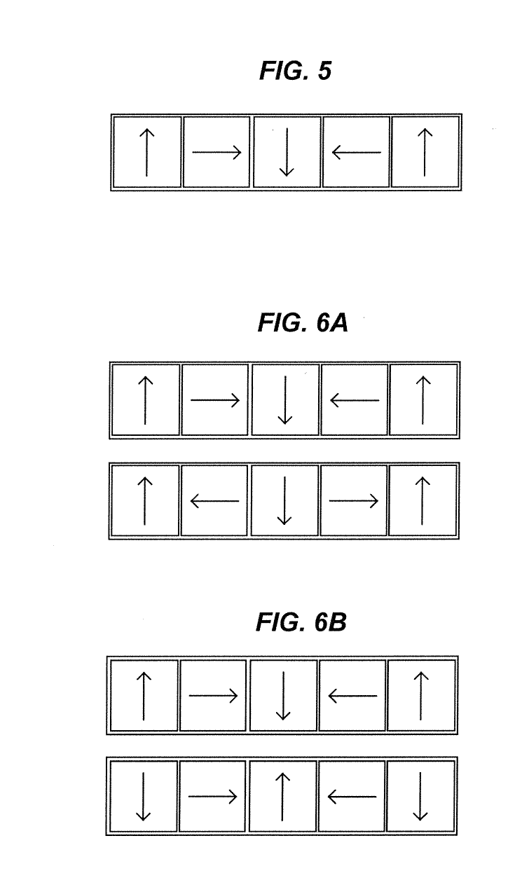

In one embodiment, the composition flows through a conduit that passes through a gap in a series of magnets in which the magnetization vectors of the magnets are arranged according to a modification of a simple Halbach array. In a Halbach array, a series of permanent magnets is arranged such that the magnetic field on one side of the array is augmented while reducing the field to very low values on the other side. In a typical Halbach array of block magnets, the magnetization direction of each magnet in the series is rotated a specified angle in either a clockwise or counterclockwise direction. FIG. 5 illustrates an example of this concept in which each successive magnetic element in the array is rotated 90 degrees. The result of this arrangement is that the magnetic field lies predominantly along only along one face of the array.

In another embodiment utilizing a split ring design, each half of the array comprises a series of complete magnetic circuits (a double Halbach design). In FIG. 6a, the double Halbach, aligned array, every other split ring pair is diametrically aligned, whereas the other elements that separate the diametric elements are axial and antipodal. In a further embodiment, the diametrically aligned split pairs may be fused into whole magnets that are diametrically magnetized. The axial split ring elements serve to direct the field of a neighboring diametric element along the axial direction and through the adjoining diametric element into the space between the halves of the array, resulting in a weaker magnetic field on the exterior of the array and a stronger magnetic field in the space between the arrays. In the embodiment shown in FIG. 6a, the split axial pair is antipodal. This configuration results in a series of complete magnetic circuits through both halves of the array.

In a further embodiment (“double Halbach, opposed”), the axial split elements are aligned and the alternating diametric elements are antipodal (see FIG. 6b). In a yet further embodiment, each axial split element pair in this design may be fused into a whole magnet with axial magnetization. The diametric elements alternate in series between antipodal (N to N) and antipodal (S to S) configurations. As in the double Halbach aligned arrangement, this arrangement also directs the field to the space between the halves of the array, but in an antipodal fashion, such that the field is compressed in the space between the two halves of the array (that is, the field density is higher). This configuration results in magnetic circuits that are restricted to each half of the array.

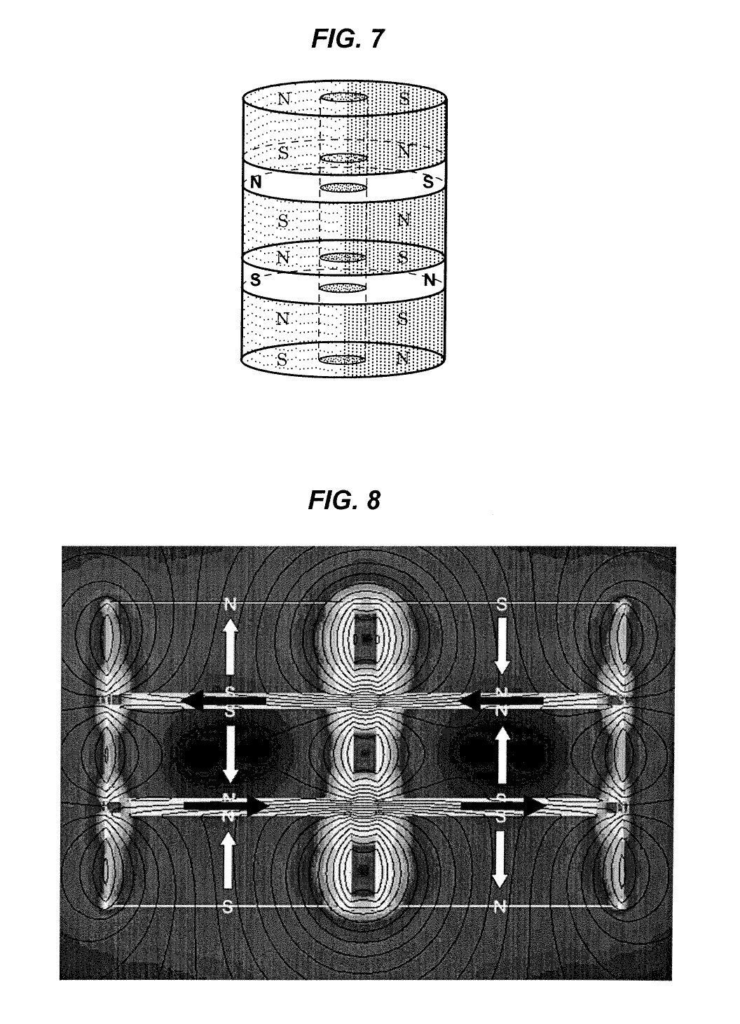

As shown in FIG. 7, another embodiment shows a split ring array configuration (“double Halbach aligned”) where the magnets are stacked. The diametrically magnetized elements may either be split pairs or whole magnets that are diametrically magnetized. The magnetization polarity is designated by N or S. The array may consist of any number of magnets with the repeated magnetization pattern illustrated in FIG. 7. The alternating magnets may have any dimension. For example, alternating thin elements alternate between thicker elements as shown in FIG. 7. In the double Halbach designs, the magnetic field is almost entirely focused in tight zones within the vertical central bore of the array. This is illustrated in FIG. 8, generated by performing a finite-element analysis (using Vizimag, version 3.1, by J. Beeteson, 2005) on the array shown in FIG. 7.

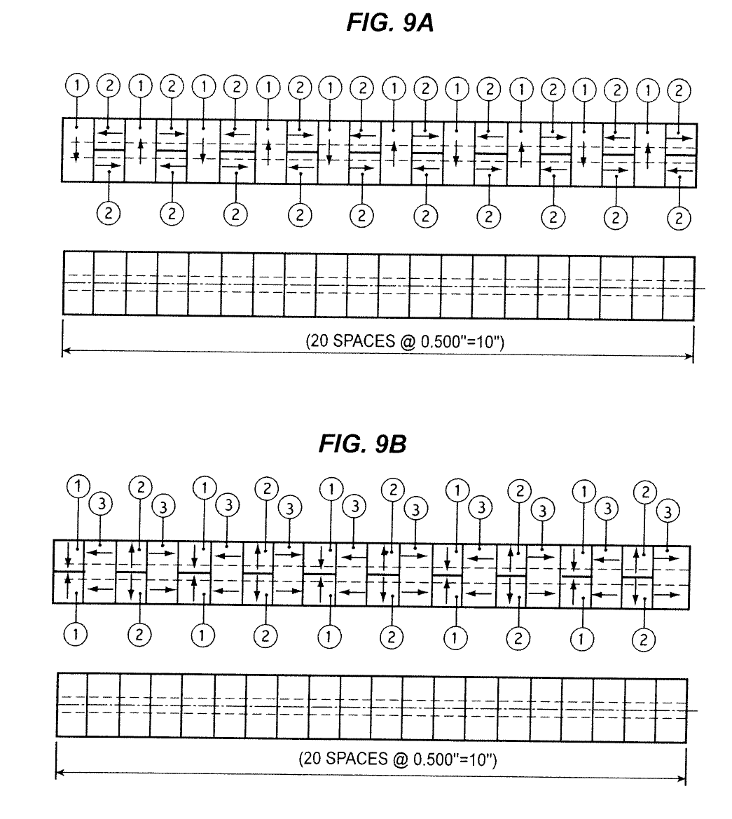

FIGS. 9a and 9b show two embodiments of double Halbach arrangements that were experimentally tested in the Examples. Each array was composed of twenty elements. This double Halbach arrangement may be thought of as a composite of two Halbach arrays, each comprised of a series of half magnets, or combinations of split pair elements (antipodal) and whole magnets. In the first embodiment (the Halbach Aligned design), the magnetization vectors for the stack of ring magnets are oriented as shown in FIG. 9a. The magnetization for the segments (whole magnets) labeled “1” is diametric (transverse), and perpendicular to the major (long) axis of the array. In the segments labeled “2”, the magnets are split and vectors on both halves of each segment are anti-parallel to each other and parallel to the major axis. The field directions are reversed for every other axial element pair.

In a further embodiment (the Halbach opposed design), the magnetization vectors for the array are oriented as shown in FIG. 9b. The magnetization for both halves of the segments labeled “1” is diametric (transverse), antipodal (oriented in opposite directions), and perpendicular to the major (long) axis of the array. The field vectors for both halves are pointed directly at each other. In the segments labeled “2”, the vectors on both halves of each segment are antipodal and diametric (perpendicular to the major axis). Unlike the configuration of segments “1”, the field vectors for each half of the split pair are antipodal and directed away from each other. Elements labeled “3” are whole magnets that are axially magnetized. This direction is reversed for every other axial element.

As shown in FIGS. 10a and 10b, a finite element analysis in two dimensions was performed on each array configuration in FIG. 9. The 2-dimensional analysis is a mapping of field lines on a plane that bisects each array. This bisecting plane contains the central array axis and is perpendicular to the cleavage planes between split elements. The arrays in FIGS. 10a and 10b comprise series of split ring magnets, whereas the configuration shown in FIG. 10c consists of a series of whole ring magnets that are transversely (diametrically) magnetized. This configuration (FIG. 10c) is built by normally stacking ring magnets on top of one another. Because the opposite poles attract each other, it is not necessary to apply mechanical force to maintain the magnets in close proximity.

Areas with a stronger magnetic field are represented by closer line spacing. As shown, the double Halbach array opposed (FIG. 10b) generates higher field strengths and flux densities in the space encompassed by the array than the double Halbach aligned array (FIG. 10a) and the unsplit ring design (FIG. 10c). Magnetic gradients (changes in field strength per unit distance) were calculated to be somewhat similar in the two Halbach designs. The attractive force between two magnetic dipoles is proportional to the product of the field strength, density, and magnetic moment of the particle. This is expressed in the

$${F}_{μ} = \frac{χρ}{{μ}_{0}} \cdot {( \frac{d B}{d t} )}_{x} \cdot \vert {{B}_{x}}^{} \vert$$

equation:

F_{μ} is the magnetic force between two dipoles, χ is the magnetic susceptibility, ρ is the particle density, μ₀ is the magnetic permeability of free space, dB/dt is the magnetic field gradient along a direction perpendicular to the field lines, and |Bₓ| is the field strength at the particle position. Therefore, at similar magnetic gradients, higher field strengths should result in larger forces between the magnetic particles and the walls of the magnet array.

Compared with the Halbach opposed design (FIG. 10b), the whole magnet array configuration (FIG. 10c) and the Halbach aligned design (FIG. 10a) show a more diffuse field in the central space within the array. Weaker magnetic gradients correspond to these regions in these latter two arrangements.

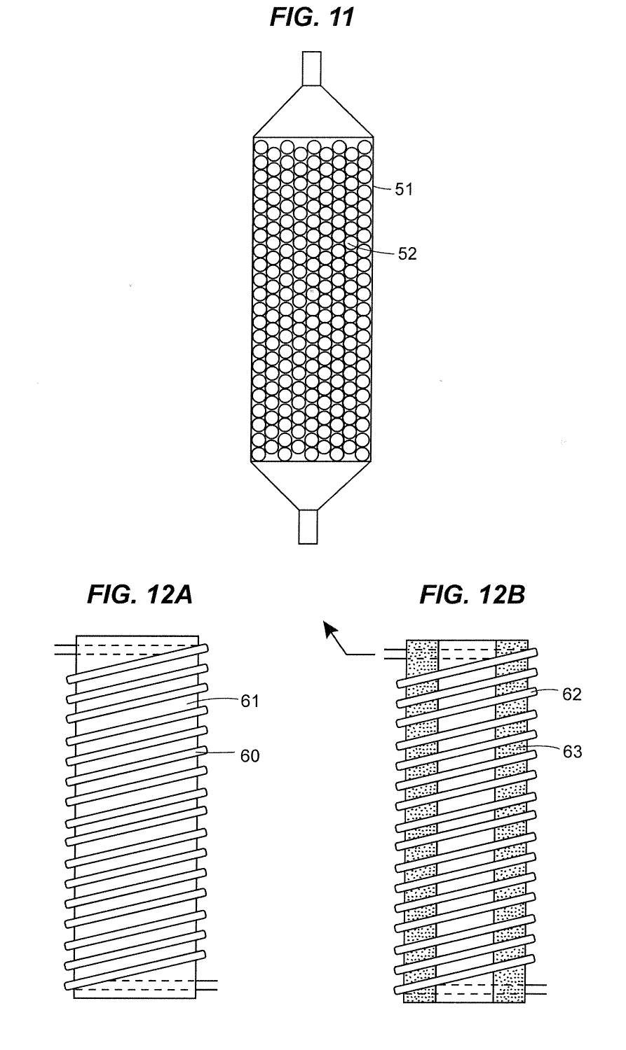

In FIG. 11, a further embodiment according to the disclosure is shown. In this embodiment, a column 51 containing one or more magnetic beads 52 is provided, with each bead possessing a high surface field strength (>1,000 gauss). The maximum surface field strength typically can be much less than that associated with ring magnets that are substantially larger than these magnetic beads. An initial composition, a fraction of which consists of ferromagnetic or paramagnetic particles, is passed through the column 51. Ferromagnetic or paramagnetic particles are attracted to the surfaces of the magnetic beads 52 within the column thereby separating the magnetized particles from the composition. The effluent dispersion contains no magnetic particles, or a reduced quantity of magnetic particles significantly less than that in the initial dispersion. The column may be inserted into devices used to process compositions or it may form an apparatus that may be used independently.

A yet further embodiment is shown in FIG. 12a. A conduit 60 is subject to a magnetic field where the conduit is adjacent to or in contact with the external surface of an arrangement 61 of one or more magnets. The arrangement of magnets may consist of one piece of magnetic material or a series of magnetic segments, which may be in direct contact with each other, or separated by metallic or non-metallic spacers. The arrangement consists of magnetic material of high surface field strength (>1,000 gauss). The conduit may, for example, be non-magnetic tubing. The conduit may assume a number of different arrangements with respect to the external surface of the arrangement of magnets. In the embodiment shown in FIG. 12a, the initial particle dispersion is directed through the conduit wound in a helix adjacent to or in contact with the outer surface of the solid magnetic arrangement 61 as shown in FIG. 12a. In an alternative embodiment shown in FIG. 12b, the conduit 62 is adjacent an arrangement of magnets in the form of a tube 63. In both embodiments, the ferromagnetic or paramagnetic particles are attracted to the inner surface of the non-magnetic tubing closest to the magnetic cylinder thereby separating the magnetized particles from the initial particle dispersion.

### Example 1

This Example describes purification of pharmaceutical solid in a liquid process stream. Three magnetic array separators were tested, each of the following types:

(a) Whole magnet array (diametric, alternating antipodal segments)

(b) Double Halbach array aligned

(c) Double Halbach array opposed.

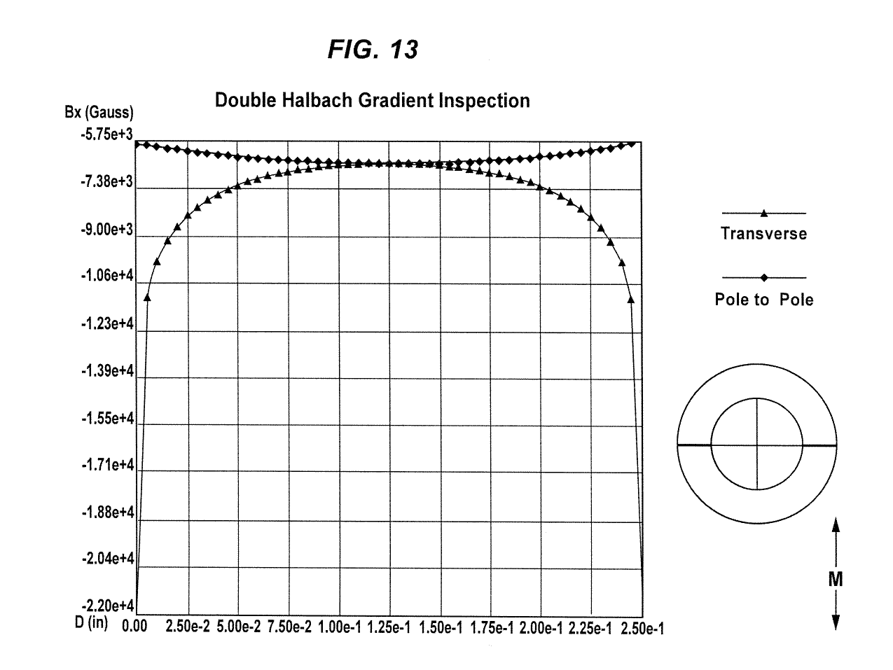

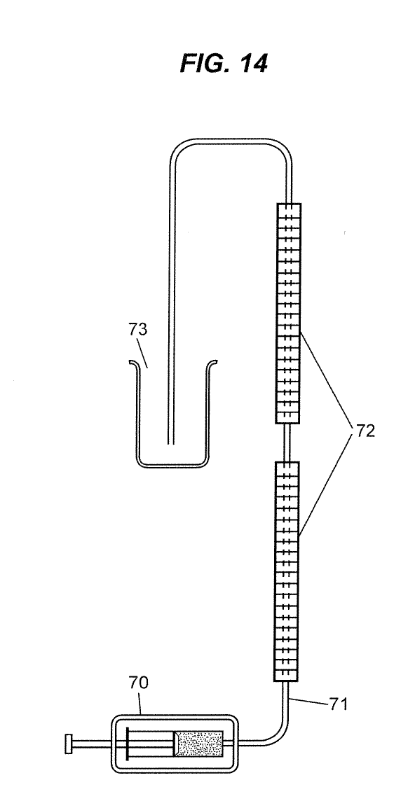

Each magnetic element (split or whole ring magnet), was fabricated from neodymium-iron-boron (NdFeB) alloy (DuraMagnetics, Sylvania, Ohio). The magnetic field strength of a whole magnet was measured on its outside surface using a DC magnetometer (AlphaLab Inc.), and was found to have a maximum field strength of approximately 5,000 gauss (0.5 tesla). Finite element analysis estimated field strengths as high as 5,700 gauss for each magnet, and strong gradients near the inner surface of the central bore of the ring magnet (see FIG. 13) near the junction of the two half elements. The outer diameter of the ring was 1-inch, the inner diameter (of the center hole) was ¼ inch (6.35 mm), and the thickness was ½ inch (12.7 mm).

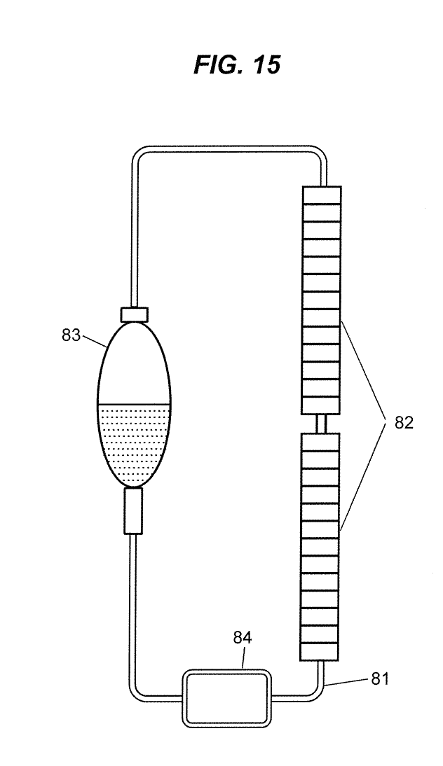

Systems as shown in FIG. 14 and FIG. 15 were used to separate magnetic material consisted of two 20-magnet arrays combined in series, vertically arranged, and collinear. Two setups were used, one for single-pass studies (FIG. 14), and another for multiple passes through the array (FIG. 15). The system using a syringe pump is shown in FIG. 14. Silicone tubing 71 (153 cm Tygon Sanitary Silicone Tubing, Formulation 3350, Saint-Gobain Performance Plastics) with an outer diameter of ¼ inch (6.35 mm) and wall thickness of 1/32 inch (0.79 mm) was passed through the bore of two magnetic arrays 72, connecting the two in series. The tubing 71 extending from the bottom of the array was connected to a syringe pump 70, and the other end was inserted into a beaker 73 to collect the effluent. Fresh tubing was used in each experiment. A 1% (w/v) composition of drug in a liquid vehicle was prepared by precipitation of the drug, followed by homogenization to reduce drug particle sizes. The drug particles were diamagnetic. The volume-weighted mean drug particle size was 0.485, and particles at the 99^{th} percentile were less than <1.71 μm. The composition also contained particles that were either ferromagnetic (e.g., steel), paramagnetic (e.g., titanium, aluminum), or a combination thereof.

The syringe pump 70 (see FIG. 14) was equipped with a 60-cc syringe, filled with 10 mL of the composition. An aliquot of unprocessed starting material was saved as a control. In one set of experiments, the suspension was passed through the magnetic array in one pass, and was not recirculated. The pump was started at a specified flow rate and 10 mL of eluent was collected.

To recirculate the composition through the magnetic arrays (5 passes), a system using a peristaltic pump was used (see FIG. 15). A composition was passed through tubing 81, through the bore of two magnetic arrays 82 and then to an addition funnel 83. Under the action of the pump 84 the suspension was recirculated through the arrays 82. Sixteen trials were conducted (8 single pass studies, and 8 multiple pass studies), under conditions shown in Table 1. A run through the same length of tubing, in the absence of the magnetic array was carried out as a control (“NO ARRAY”).

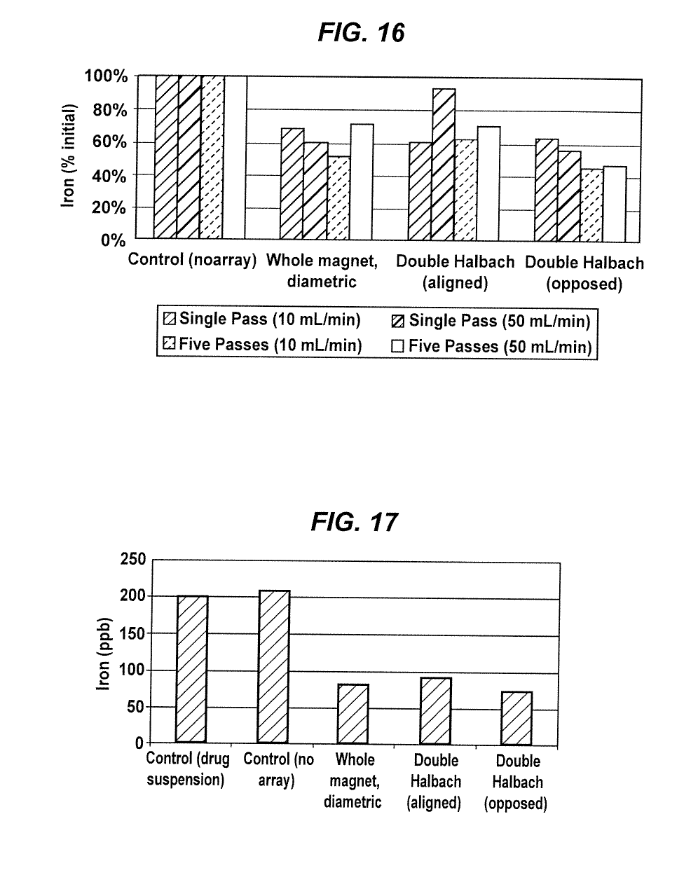

Drug particle size populations were determined by static laser diffraction (Horiba LA-920). The method is described in the following article: J. Wong, P. Papadopoulos, J. Werling, C. Rebbeck, M. Doty, J. Kipp, J. Konkel and D. Neuberger,” Itraconazole Suspension for Intravenous Injection: Determination of the Real Component of Complete Refractive Index for Particle Sizing by Static Light Scattering,” PDA J. Pharm. Sci. Technol., 60, 302-313 (2006) and D. Neuberger and J. Wong, “Suspension for Intravenous Injection: Image Analysis of Scanning Electron Micrographs of Particles to Determine Size and Volume,” PDA J. Pharm. Sci. Technol., 59, 187-199 (2005). Measurements were obtained using five milliliters of each collected sample. The remaining five milliliters of each sample were centrifuged at 10,000 RCF for 1 hour (Beckman Coulter, Allegra™ 64R Centrifuge with C1015 Rotor) and the centrifuge tubes were visually examined for separation of dense, dark metal particles. These samples were resuspended and analyzed for iron content by emission spectroscopy (Perkin-Elmer Aanalyst™ 600 Atomic Absorption Spectrometer with THGA Graphite Furnace). Table 2 shows the iron content (in ppb) of each sample. The data are plotted in FIG. 16. FIG. 16 is a plot of residual iron versus that in the control (unprocessed) suspension.

TABLE 1

| | | Flow rate | Number |
|---|---|---|---|
| No | Run description | (mL/min) | of passes |
| 1 | Control (no array) | 10 | 1 |
| 2 | Control (no array) | 50 | 1 |
| 3 | Whole magnet, diametric | 10 | 1 |
| 4 | Whole magnet, diametric | 50 | 1 |
| 5 | Double Halbach (aligned) | 10 | 1 |
| 6 | Double Halbach (aligned) | 50 | 1 |
| 7 | Double Halbach (opposed) | 10 | 1 |
| 8 | Double Halbach (opposed) | 50 | 1 |
| 9 | Control (no array) | 10 | 5 |
| 10 | Control (no array) | 50 | 5 |
| 11 | Whole magnet, diametric | 10 | 5 |
| 12 | Whole magnet, diametric | 50 | 5 |
| 13 | Double Halbach (aligned) | 10 | 5 |
| 14 | Double Halbach (aligned) | 50 | 5 |
| 15 | Double Halbach (opposed) | 10 | 5 |
| 16 | Double Halbach (opposed) | 50 | 5 |
| 17 | Control (unprocessed sample) | — | — |

TABLE 2

| | | Flow rate | Number | Iron |
|---|---|---|---|---|
| No | Run description | (mL/min) | of passes | (ppb) |
| 1 | Control (no array) | 10 | 1 | 106 |
| 2 | Control (no array) | 50 | 1 | 116 |
| 3 | Whole magnet, diametric | 10 | 1 | 72.0 |
| 4 | Whole magnet, diametric | 50 | 1 | 69.3 |
| 5 | Double Halbach (aligned) | 10 | 1 | 63.9 |
| 6 | Double Halbach (aligned) | 50 | 1 | 107.8** |
| 7 | Double Halbach (opposed) | 10 | 1 | 66.8 |
| 8 | Double Halbach (opposed) | 50 | 1 | 63.7 |
| 9 | Control (no array) | 10 | 5 | 145 |
| 10 | Control (no array) | 50 | 5 | 138 |
| 11 | Whole magnet, diametric | 10 | 5 | 74.6 |
| 12 | Whole magnet, diametric | 50 | 5 | 97.9 |
| 13 | Double Halbach (aligned) | 10 | 5 | 89.9 |
| 14 | Double Halbach (aligned) | 50 | 5 | 96.8 |
| 15 | Double Halbach (opposed) | 10 | 5 | 64.2 |
| 16 | Double Halbach (opposed) | 50 | 5 | 63.8 |
| 17 | Control (unprocessed sample) | — | — | 154 |

*Average of two runs.
**Possible outlier

FIG. 16 indicates that all magnet arrays reduced iron particle content. The double Halbach opposed design showed surprisingly superior capability in removing iron from a particle stream. The efficiencies of the whole magnet design (whole magnet diametric) and the double Halbach aligned design were similar. The double Halbach opposed design showed significantly better particle removal capability at the higher flow rate (50 mL/min). The cumulative effect of five passes through the array enhanced this difference (see FIG. 16).

### Example 2

The effect of higher flow rate on particle removal was examined in this Example. The system shown in FIG. 15 was used. Silicone tubing (153 cm, ¼ inch (6.35 mm) outer diameter, with wall thickness of 1/32 inch (0.794 mm)) was used, and was replaced for each experiment. A segment of the tubing was threaded through the peristaltic pump. A solid suspension that contained non-magnetic drug particles (mean=0.506 μm and 99% less than 2.46 μm) and also contained iron impurities was passed once through each array at 100 cc/min. Test samples are listed in Table 3.

TABLE 3

| No | Sample description |
|---|---|
| 1 | Control (drug suspension) |
| 2 | Control (tubing only, no magnets) |
| 3 | Double Halbach (opposed) |
| 4 | Double Halbach (aligned) |
| 5 | Whole magnet (diametric) |

The results are presented in FIG. 17. As in Example 1, the Halbach opposed array demonstrated superior removal capability at higher flow rate.

### Example 3

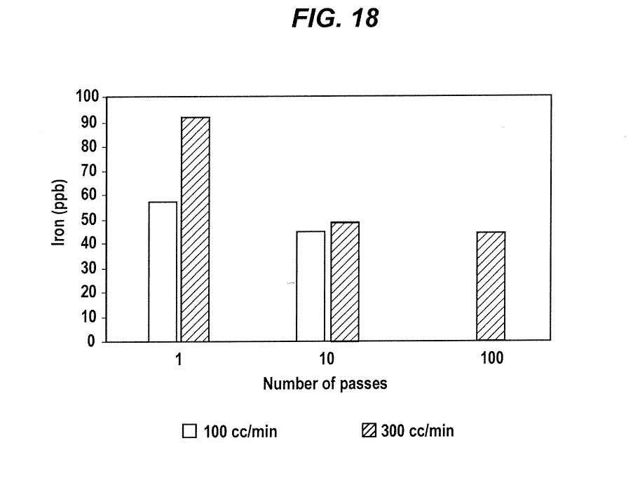

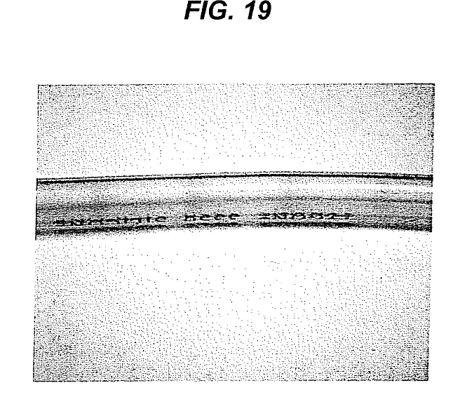

This Example examined the effect of multiple passes on particle separation (double Halbach opposed). A 1% (w/v) pharmaceutical suspension with metal particles was passed once, 10 times, and 100 times, through the double Halbach opposed array at a flow rate of either 100 or 300 cc/min. The experimental setup in FIG. 15 was used. Results, plotted in FIG. 18, indicate that multiple passes improved magnetic particle removal.

### Example 4

In this Example, water was used to wash a system that is used to manufacture pharmaceutical compositions. This Example also indicates the efficiency of this invention for removing magnetic material from solutions. The water was flushed through the system and a sample of the flushed water examined for the presence of magnetic material. In Control experiments, no magnetic array was included in the system and in Experimental samples a magnetic array was included as indicated in Table 4.

Water was flushed through the system at 15000 psi for 60 minutes or pumped using a peristaltic pump. A sample of the flushed or pumped water was removed and magnetic particle size populations were determined by static laser diffraction. In Table 4, results of magnetic particle numbers and sizes are shown both as differential and cumulative counts are shown for three separate experiments.

TABLE 4

| | | | Differential Counts | | | | | |
|---|---|---|---|---|---|---|---|---|
| | Treatment | Sample | 5 to <10 | 10 to <25 | | Cumulative Counts | | |
| Run | Description | Description | μm | μm | ≧25 μm | >5 μm | >10 μm | >25 μm |
| 1-No array | Control- 15 kpsi- | Water | 27797 | 250 | 0 | 28047 | 250 | 0 |
| | Flush-60 min-1 | Sample no | | | | | | |
| | | array | | | | | | |
| 1-After | Experimental- | Water | 273 | 63 | 8 | 344 | 71 | 8 |
| magnetic | 15 kpsi-Flush- | Sample after | | | | | | |
| separation | 60 min-1-Double | Passing | | | | | | |
| | Halbach Opposed | Through 2 | | | | | | |
| | design | Columns, | | | | | | |
| | | Double | | | | | | |
| | | Halbach | | | | | | |
| | | Opposed | | | | | | |
| | | design | | | | | | |
| 2-No array | Control-15 kpsi- | Water | 30797 | 218 | 1 | 31016 | 219 | 1 |
| | Flush-60 min-2 | Sample no | | | | | | |
| | | array | | | | | | |
| | Experimental- | Water | 1066 | 104 | 14 | 1184 | 118 | 14 |
| | 15 kpsi-Flush- | sample after | | | | | | |
| | 60 min-2-Double | Passing | | | | | | |
| | Halbach Opposed | Through 2 | | | | | | |
| | design | Columns, | | | | | | |
| | | Double | | | | | | |
| | | Halbach | | | | | | |
| | | Opposed | | | | | | |
| | | design | | | | | | |
| 3-No array | Control-15 kpsi- | Water | 28238 | 192 | 2 | 28432 | 194 | 2 |
| | Flush-60 min-3 | Sample no | | | | | | |
| | | array | | | | | | |
| 3-After | Experimental | Water | 1537 | 126 | 12 | 1675 | 138 | 12 |
| magnetic | Double Halbach | Sample | | | | | | |
| separation | Opposed design, | After | | | | | | |
| | Peristaltic pump | Passing | | | | | | |
| | | Through 2 | | | | | | |
| | | Columns, | | | | | | |
| | | Double | | | | | | |
| | | Halbach | | | | | | |
| | | Opposed | | | | | | |
| | | design | | | | | | |

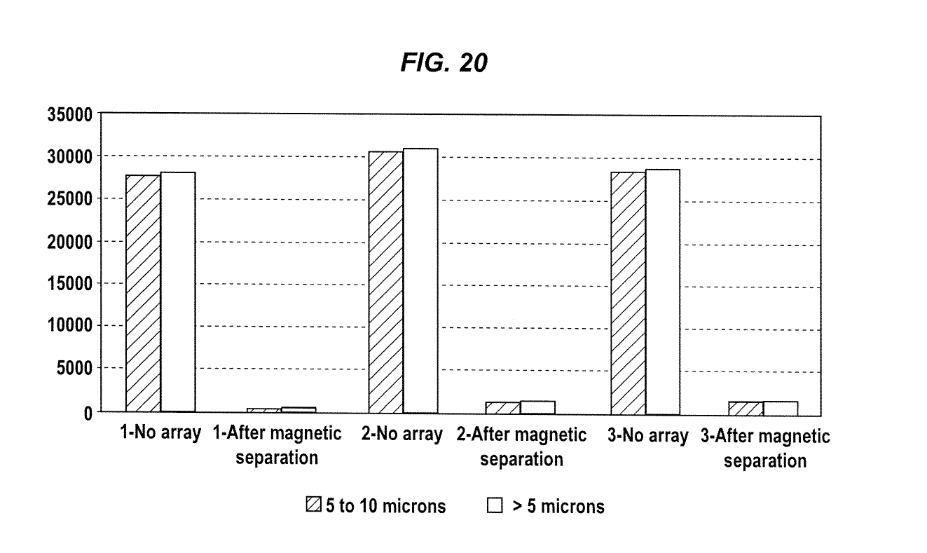

FIG. 20 indicates that for water, as a solution example, the magnetic array was surprisingly successful in removing magnetic particles (99% removal for trial #1). The magnetic array was particularly successful at removing particles between 5 and 10 microns (greater than 99% removal for trial #1).

It will be understood that the embodiments of the present disclosure which have been described are illustrative of some of the applications of the principles of the present disclosure. Numerous modifications may be made by those skilled in the art without departing from the true spirit and scope of the disclosure. Various features which are described herein can be used in any combination and are not limited to procure combinations that are specifically outlined herein.

1. An apparatus for removing material with magnetic properties from a composition, comprising:
a conduit wherein said conduit has first and second ends and wherein said conduit defines an interior volume;
an magnetic arrangement of at least one permanent magnet that defines a space, and said conduit lies at least partially within said space such that a magnetic field is generated within at least a portion of said interior volume; and
wherein said composition flows through said conduit and is subject to said magnetic field.

2. The apparatus of claim 1 wherein said magnetic field is generated by one magnet.

3. The apparatus of claim 1 wherein said magnetic field is generated by a plurality of magnets.

4. The apparatus of claim 1 wherein said magnetic field is approximately parallel to said flow of said composition.

5. The apparatus of claim 1 wherein said magnetic field is approximately perpendicular to said flow of said composition.

6. The apparatus of claim 3 wherein the respective magnetic fields of at least two of said plurality of magnets are arranged in the same orientation.

7. The apparatus of claim 3 wherein the respective magnetic fields of said plurality of magnets are arranged in the same orientation.

8. The apparatus of claim 3 wherein said plurality of magnets comprises bar, block, horseshoe or ring magnets.

9. The apparatus of claim 3 wherein said plurality of magnets are ring magnets.

10. The apparatus of claim 9 wherein said ring magnets are split in halves.

11. The apparatus of claim 9 wherein a combination of whole ring magnets and ring magnets that are split in halves are used.

12. The apparatus of claim 11 wherein the orientation of the magnetic field of said whole ring magnets are selected from the group consisting of: perpendicular to said flow of said composition and parallel to said flow of said composition.

13. The apparatus of claim 11 wherein the orientation of the magnetic field of said halves of each ring magnet are selected from the group consisting of: aligned and perpendicular to said flow of said composition; antipodal and perpendicular to said flow of said composition with North poles abutting; antipodal and perpendicular to said flow of said composition with South poles abutting; aligned and parallel to said flow of said composition; and antipodal and parallel to said flow of said composition.

14. The apparatus of claim 3 wherein said plurality of magnets forms at least one double Halbach array

15. The apparatus of claim 12 wherein said at least one double Halbach array is in an aligned configuration

16. The apparatus of claim 12 wherein said at least one double Halbach array is in an opposed configuration.

17. The apparatus of claim 1 wherein said composition is pharmaceutical composition containing an active agent.

18. The apparatus of claim 15 wherein said pharmaceutical composition is a homogeneous solution of an active agent.

19. The apparatus of claim 15 wherein said pharmaceutical composition contains dispersed particles of an active agent.

20. The apparatus of claim 17 wherein said dispersed particles of said active agent are diamagnetic.

21. The apparatus of claim 1 wherein material with magnetic properties is ferromagnetic or ferrimagnetic.

22. The apparatus of claim 1 wherein material with magnetic properties is paramagnetic.

23. The apparatus of claim 1 wherein material with magnetic properties is in the form of particles of less than about 100 um in diameter.

24. The apparatus of claim 1 wherein material with magnetic properties is derived from equipment used in the production of said composition.

25. The apparatus of claim 1 wherein said material with magnetic properties is autensitic.

26. The apparatus of claim 1 wherein said material with magnetic properties is martensitic.

27. The apparatus of claim 1 wherein material with magnetic properties is in the form of particles composed of steel.

28. The apparatus of claim 1 wherein the interior surface of said conduit retains said magnetic material when said magnetic material contacts said interior surface.

29. The apparatus of claim 3 wherein said conduit is situated adjacent to an external surface of said magnetic arrangement.

30. The apparatus of claim 1 wherein said conduit forms a helical path adjacent to the external surface of said magnetic arrangement.

31. The apparatus of claim 1 wherein said composition that flows through said conduit includes undesirable particles responsive to the magnetic field and said conduit volume excludes other components other than said magnetic particles that are responsive to said magnetic field.

32. An apparatus for removing material with magnetic properties from a composition, comprising:
a conduit wherein said conduit has first and second ends and wherein said conduit defines an interior volume;
an arrangement of magnets selected from the group consisting split and whole ring magnets, such that said arrangement forms at least one double Halbach opposed array magnetic field; and
said conduit lies at least partially within the space between formed by said double Halbach opposed array and said composition is subject to said magnetic field.

33. An apparatus for removing material with magnetic properties from a composition, comprising:
a column wherein said column has first and second open ends and wherein said conduit defines an interior volume;
an arrangement of beads of permanent magnets such that a magnetic field is generated within at least a portion of said interior volume; and
said composition flows through said column and through said magnetic field.

34. A system for removing material with magnetic properties from a composition, comprising:
at least one device used to produce a composition;
a conduit, said conduit having first and second ends, one end of said conduit being adapted to receive said composition from said device; and
an arrangement of at least one magnet such that a magnetic field is generated within at least a portion of said interior volume of said conduit, whereby material with magnetic properties is removed from said composition.

35. A method to produce a composition substantially free of material with magnetic properties comprising the steps of:
a) providing a composition containing material with magnetic properties;
b) passing said composition through a conduit;
c) herein at least a portion of said conduit is exposed to a magnetic field generated by an arrangement of at least one permanent magnet; and
d) collecting said pharmaceutical composition after passage through said conduit.

36. The process of claim 32 wherein said magnetic field is provided by an arrangement of magnets that forms at least one double Halbach array.

37. The process of claim 32 wherein said magnetic field is provided by an arrangement of magnets that forms at least one double Halbach array in an opposed configuration.

38. The process of claim 32 wherein said magnetic field is provided by an arrangement of magnets that forms at least one double Halbach array in an aligned configuration.

39. The process of claim 32 wherein said pharmaceutical composition is a homogeneous solution of an active agent.

40. The process of claim 32 wherein said pharmaceutical composition contains dispersed particles of an active agent.

41. The process of claim 32 wherein said dispersed particles of said active agent are diamagnetic.

42. An apparatus for removing material with magnetic properties from a composition, comprising:
a conduit wherein said conduit has first and second ends and wherein said conduit defines an interior volume;
an arrangement of permanent magnets that generates a magnetic field; and
said conduit is adjacent to or in contact with the external surface of said arrangement of magnets and said composition is subject to said magnetic field.

43. The apparatus of claim 39 wherein said conduit forms a helical path adjacent to the external surface of said arrangement of magnets.
